(19) United States
(12) Patent Application Publication
(10) Pub. No.: US 2008/0026177 A1
(43) Pub. Date: Jan. 31, 2008

(54) Molded Carpet Part with an Acoustic Function for Motor Vehicles and Method for Producing Same

(76) Inventor: Herbert Vollmert, Nettetal (DE)

Correspondence Address: WILLIAM COLLARD;COLLARD & ROE, P.C., 1077 NORTHERN BOULEVARD, ROSLYN, NY, 11576, US

(21) Appl. No.: 11/667,255

(22) PCT Filed: Nov. 8, 2005
(86) PCT No.: PCT/EP05/11901

§ 371 Date: Jul. 20, 2007

(30) Foreign Application Priority Data
Nov. 9, 2004 (DE) 10 2004 054 299.6

(51) Int. Cl. B32B 3/02; B28B 1/00

(52) U.S. Cl. 428/95; 264/655

(57) ABSTRACT

The invention relates to a molded carpet part for motor vehicles with an acoustic function, in particular for use as the floor covering of a passenger compartment, comprising an upper textile material (1), which is connected to a carpet backing (5) by means of a multi-layer material composite (2-4), as well as a method for producing a molded carpet part of this type. The molded carpet part can be produced to a great extent without shrinkage and with a high fitting accuracy. This is achieved according to the invention by configuring the material composite that is located between the upper material (1) and the carpet backing (5) from a first needle punched nonwoven (2) consisting of bi-component fused fibres, which is bonded to the upper material, a subsequent second needle punched nonwoven (3) consisting of single component fibres and a subsequent third needle punched nonwoven (4) consisting of bi-component fused fibres. To produce the molded carpet part, the upper textile material (1) is moistened prior to the hot embossing process.

The invention relates to a molded carpet part for motor vehicles with an acoustic function, in particular for use as the floor covering of a passenger compartment, comprising an upper textile material, which is connected to a carpet backing by means of a multi-layer material composite, as well as a method for producing a molded carpet part of this type.

It is known to produce carpet flooring for the passenger compartment of a motor vehicle by hot forming (hot embossing) by means of a heated forming tool or to fit to the contour of the vehicle floor in the heated state by cold forming using an unheated forming tool. With the carpet composite materials conventionally used, shrinkage usually occurs in the molded part during the hot forming. This shrinkage is problematical if the finished molded carpet part does not have the required fitting accuracy as a result of shrinkage.

It is the object of the present invention to provide a material structure whereby a largely shrinkage-free molded carpet part having a high fitting accuracy can be produced. In particular, a molded carpet part is to be provided which remains substantially free from shrinkage even under considerable climatic changes. Furthermore, a cost-effective method for producing such a molded carpet part should be provided.

This object is achieved according to the invention by a molded carpet part having the material structure specified in claim 1 or by the method defined in claim 11.

The molded carpet part according to the invention comprises an upper textile material which is connected to a carpet backing by means of a multi-layer material composite, the material composite that is located between the upper textile material and the carpet backing being formed from a first needle punched nonwoven consisting of bi-component fused fibres, which is bonded to the upper material, a subsequent second needle punched nonwoven consisting of single component fibres and a subsequent third needle punched nonwoven consisting of bi-component fused fibres.

It was found that the aforesaid material composite effectively counteracts any shrinkage of the carpet floor material structure so that substantially shrinkage-free molded carpet parts having a high fitting accuracy can be achieved.

Bi-component fused fibres are comparatively expensive. However, in order to achieve substantially shrinkage-free molded carpet parts, it is sufficient if the two needle punched nonwovens formed of bi-component fibres are relatively thin or have a relatively low weight per unit area. The material costs are thus within acceptable limits. According to a preferred embodiment, it is provided that the two needle punched nonwovens formed from bi-component fibres each have a weight per unit area of less than 200 g/m², in particular less than 150 g/m², for example about 100 g/m².

For the desired freedom from shrinkage of the molded carpet parts, the two needle punched nonwovens formed from bi-component fibres should each consist of at least 85 vol. % of bi-component fused adhesive fibres. Preferably however, these needle punched nonwovens consist as completely as possible, i.e. up to 100% if possible, of bi-component fused adhesive fibres.

With regard to pure-grade recycling, it is advantageous if the various material layers of the molded carpet part consist of only one type of plastic. The individual material layers of the molded carpet part according to the invention are preferably each manufactured of polyester. Polyester fibres give the finished molded carpet part a high abrasion strength and are odour-free and rot-resistant. As a result of the polyester fibres or the bi-component fibres used, substantially no vapours are emitted by the molded carpet part according to the invention which would be deposited as contamination on the inner side of the vehicle windscreen (so-called fogging).

Accordingly, in an advantageous embodiment of the molded carpet part according to the invention, bi-component fused fibres are used, wherein the core is formed of polyester and the sheath is formed of polyester having a melting point below the melting point of the core.

The method according to the invention for producing the molded carpet part according to the invention is substantially characterised in that the upper textile material and the multilayer material composite comprising the needle punched nonwovens formed from bi-component fibres or single-component fibres are hot embossed with or without the carpet backing in a heated forming device, the upper textile material being moistened with water before the hot embossing.

Any excessive heating can result in an undesirable shine effect on the upper textile material. The moistening of the upper textile material prevents excessive heating of the upper textile material during the hot embossing. The evaporation of the moisture is associated with a local temperature limitation in the area of the upper textile material. The material composite to be bonded to the upper textile material can thus be heated more rapidly to the required temperature for fusing the bi-component fibres, that is, for softening or melting the sheathing material of the bi-component fibres. The method according to the invention thus allows cycle times to be reduced which means higher productivity or lower production costs.

No additional adhesive in powder form or in the form of an adhesive film is used in the production of the molded carpet part according to the invention. The method according to the invention also dispenses with the use of a heating device upstream of the forming device since the forming tools of the forming device used are embodied as heatable. The required machine investment costs can be reduced by eliminating an upstream heating device.

With regard to avoiding an undesirable shine effect on the upper textile material, it is advantageous if, according to a preferred embodiment, a forming device comprising heatable forming tools whose temperature can be adjusted independently of one another is used for the hot embossing where the forming tool facing the upper textile material is operated at a temperature at least 10° C. lower than the forming tool facing the multi-layer material composite or the carpet backing.

Further features of the molded carpet part according to the invention and the method for its production are specified in the dependent claims.

The invention is explained in detail hereinafter with reference to drawings showing several exemplary embodiments. Shown schematically in the figures:

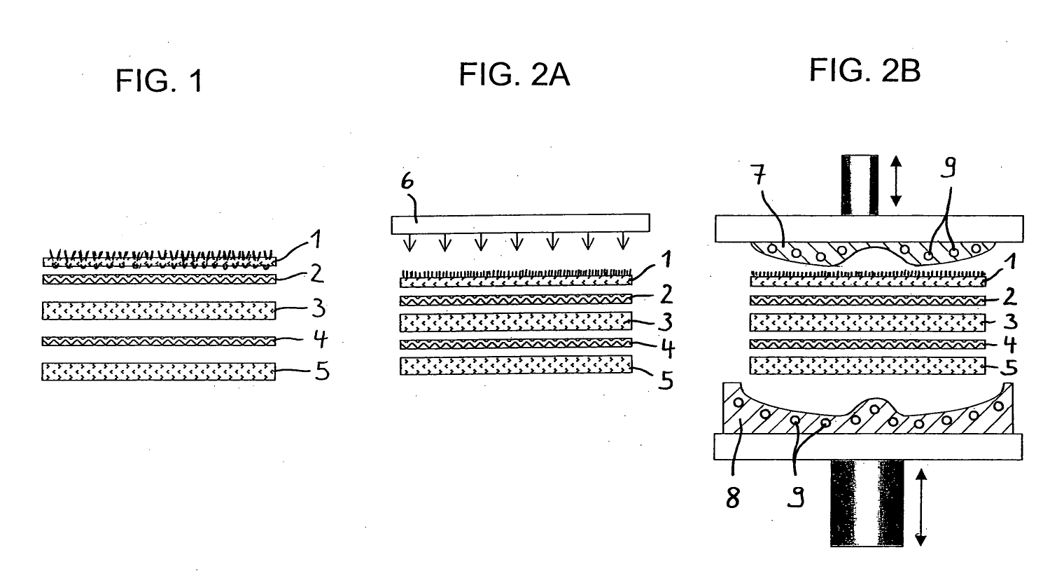

FIG. 1 is a preferred material structure of a molded carpet part according to the invention;

FIGS. 2A and 2B show process steps for producing a molded carpet part according to the invention; and

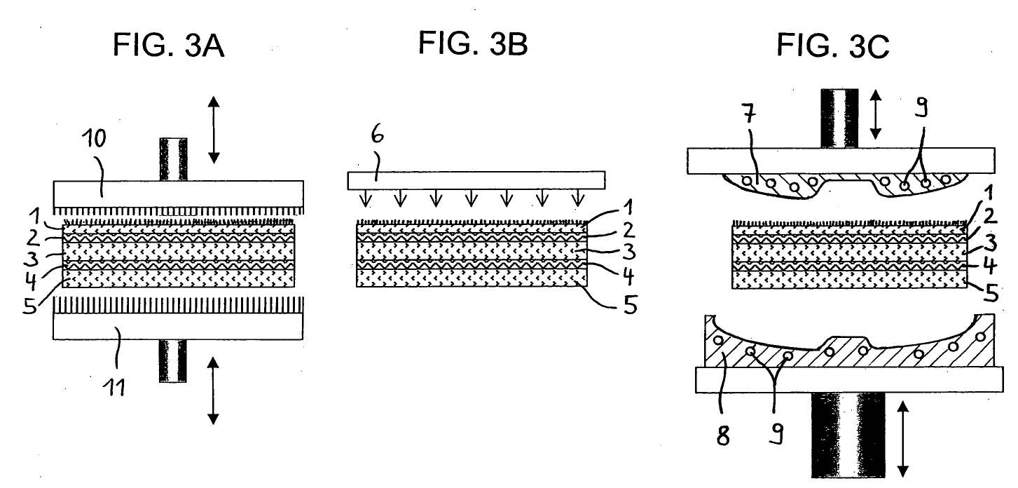

FIGS. 3A 3B and 3C show process steps for producing a molded carpet part according to one variant of the invention.

The molded carpet part according to the invention can be used in particular as a floor covering having an acoustic function in the passenger compartment of a motor vehicle. Other possible application are the cladding of the floor and the side parts of a trunk of a motor vehicle.

The size of the molded carpet part according to the invention preferably corresponds to the size of vehicle floor to be covered so that the vehicle floor can be completely covered with the one-piece molded carpet part. The molded carpet part can thus be relatively large, in which case it is fitted to all recesses and tunnel-like elevations of the vehicle floor.

As shown schematically in FIG. 1, the molded carpet part according to the invention is formed from an upper textile material 1, a first needle punched nonwoven 2 consisting of bi-component fused adhesive fibres, a second needle punched nonwoven 3 consisting of single-component fibres, a third needle punched nonwoven 4 consisting of bi-component fused adhesive fibres and optionally a carpet backing 5 (second backing).

The upper textile material 1 preferably consists of a tufted fabric, where a nonwoven consisting of polyester and/or polypropylene fibres can be used in particular as the tuft support. The nap material (pile material) of the upper textile material 1 can comprise, for example, fibres, yarns or twists of polyamide, polyester or polypropylene as well as mixtures thereof, where the pile material can additionally also contain bi-component fibres. The fraction of bi-component fibres in the pile-forming mixture is optionally around 10 vol. %.

Instead of a tufted fabric, if necessary a dilour fabric, a malimo fabric, a maliwatt fabric, a knitted fabric or a nonwoven fabric can be used as upper fabric material 1.

The first needle punched nonwoven 2 directly following the upper textile material 1 is preferably made of 100% bi-component fibres. The weight per unit area of the needle punched nonwoven 2 is less than 200 g/m²; for example, it is around 100 g/m².

The bi-component fibres each have a sheathing which has a significantly lower melting point than the core. The sheathing material can consist, for example, of polypropylene and the core material of polyester. Preferably used to produce the molded carpet part according to the invention are bi-component fibres whose core material consists of polyester and whose sheathing material consists of a modified polyester having a lower melting point.

The needle punched nonwoven 2 formed from bi-component fibres is followed by the needle punched nonwoven 3 consisting of single-component fibres. The single-component fibres can be synthetic fibres and/or natural fibres. Polyester fibres are again preferred. However, cotton fibres, for example, can also be used. The thickness and the weight per unit area of the needle punched nonwoven 3 are considerably greater than in the case of the needle punched nonwoven 2 consisting of bi-component fibres. The needle punched nonwoven 3 has a weight per unit area in the range of 300 to 700 g/m² with a fibre count in the range of 3 to 7 dtex.

The fibre length of the synthetic or natural fibres of the needle punched nonwoven 3 lies in the range, for example, of 50 to 80 mm.

The needle punched nonwoven 3 consisting of synthetic and/or natural fibres is directly followed by another needle punched nonwoven 4 consisting of bi-component fibres which is preferably configured according to the other bi-component fibre needle punched nonwoven 2 with regard to its surface weight per unit area. However, it is also within the scope of the invention to use needle punched nonwovens 2, 4 consisting of bi-component fibres having different weight or thickness. The fibre length of the bi-component fibres is preferably in the range of 30 to 90 mm.

Finally, another needle punched nonwoven or a heavy layer is arranged underneath the needle punched nonwoven 4 consisting of bi-component fibres as carpet backing (secondary backing) 5. The carpet backing 5 is comparatively thick or heavy. It has a weight per unit area in the range of 300 to 800 g/m².

If the carpet backing 5 is a heavy layer, for example, filler-containing elastomer, this is not hot-embossed together with the other metal layers 1 to 4 but is fitted to the contour of the vehicle surface to be covered or the molded carpet part in another way and bonded to the latter.

The production of a molded carpet part according to the invention is now explained with reference to FIGS. 2A and 2B. As shown in FIG. 2A, the upper textile material 1 is moistened with a suitable fluid, for example, with water before it is brought into a device for hot embossing as a loose pile with the other material layers 2 to 4 or 2 to 5.

The blank 1 can be moistened, for example, using a device 6 having a plurality of spray nozzles. The moistening prevents any excessive heating of the upper textile material 1 during the hot embossing. Excessive heating of the upper textile material 1 can cause shine effects which adversely affect the appearance of the finished molded carpet part. The moistening brings about a vapour effect which protects the fabric upper material 1 from too severe heating during the hot embossing. As a result of the moistening, it is possible to reduce the process time (cycle time) required for the hot embossing.

The forming device has heatable forming tools 7, 8 whose heating temperature can be adjusted independently. For this purpose, heating channels 9 for a heating fluid can be formed in the upper tool 7 and the lower tool 8. Alternatively, electrical heating resistors or the like can be integrated in the forming tools 7, 8.

The heating temperatures of the liftable and lowerable forming tools 7, 8 lie in the range of 50 to 160° C. depending on the condition of the upper textile material 1 used, the melting temperature of the sheathing material of the bi-component fibres and the cycle time desired for the hot embossing.

In principle, a relatively high hot embossing temperature is required to achieve short cycle times during hot forming of the material structure. In order to nevertheless protect the upper textile material 1, the forming tool 7 or 8 facing the upper textile material 1 is operated at a temperature at least 10° C. lower than that of the forming tool facing the carpet backing (needle punched nonwoven) 5 or the needle punched nonwoven 4 of the multi-layer material composite (without heavy layer).

The forming tool facing the upper textile material 1 is operated, for example at a temperature below 100° C. whilst the temperature of the other forming tool is set to a temperature in the range of 110 to 160° C.

FIGS. 3A to 3C show a variant of the production of a molded carpet part according to the invention in which material layers according to FIG. 1 are needled together before the hot embossing. The reference numerals 10, 11 denote liftable and lowerable needle beams of a needling device. However, needling of the material layers 1 to 5 can be omitted as shown in the exemplary embodiment according to FIGS. 2A and 2B.

In the drawing the upper tool of the hot embossing device is facing the upper textile material 1. However, the molded carpet part according to the invention is preferably produced in such a way that the lower tool of the hot embossing device is facing the upper textile material 1. This can prevent seepage of water or another moistening fluid from the moistened upper material 1 into the material layers 2 to 4 or 2 to 5 located thereunder. In this context, it is understood that the upper tool 7 in FIGS. 2B and 3C and the lower tool 8 can be exchanged for one another or FIGS. 2B to 3C can each be turned through 1800 so that the forming tool assigned to the upper textile material 1 is then the lower tool.

In contrast to conventional molded carpet parts, during the production of the molded carpet part according to the invention, no additional adhesive in powder form or in the form of an adhesive film is used. The binding of the pile of the upper textile material 1 and its bonding to the needle punched nonwoven 3 consisting of synthetic and/or natural fibres is effected exclusively by the sheathing material of the bi-component fibres of the needle punched nonwoven 2 fused during the hot embossing.

1. A molded carpet part for motor vehicles with an acoustic function, in particular as a one-piece floor covering of a passenger compartment, comprising an upper textile material (1), which is connected to a carpet backing (5) by means of a multi-layer material composite (2-4), wherein the material composite that is located between the upper textile material and the carpet backing is formed from a first needle punched nonwoven (2) consisting of bi-component fused fibres, which is bonded to the upper material, a subsequent second needle punched nonwoven (3) consisting of single component fibres and a subsequent third needle punched nonwoven (4) consisting of bi-component fused fibres.

2. The molded carpet part according to claim 1, wherein the first needle punched nonwoven (2) and the third needle punched nonwoven (4) are each formed from at least 85 vol. % of bicomponent fused adhesive fibres.

3. The molded carpet part according to claim 1, wherein the first needle punched nonwoven (2) and the third needle punched nonwoven (4) each have a weight per unit area of less than 200 g/m², in particular less than 150 g/m².

4. The molded carpet part according to claim 1, wherein the bicomponent fused adhesive fibres are of the coresheathing fibre type, wherein the core is formed of polyester and the sheathing is formed of polyester having a melting point below the melting point of the core.

5. The molded carpet part according to claim 1, wherein the bi-component fused adhesive fibres have a length in the range of 30 to 90 mm.

6. The molded carpet part according to claim 1, wherein the second needle punched nonwoven (3) has a weight per unit area in the range of 300 to 700 g/m² with a fibre count in the range of 3 to 7 dtex.

7. The molded carpet part according to claim 1, wherein the second needle punched nonwoven (3) is formed of polyester fibres.

8. The molded carpet part according to claim 1, wherein the carpet backing (5) is formed of a needle punched nonwoven or of a heavy layer.

9. The molded carpet part according to claim 1, wherein the carpet backing (5) has a weight per unit area of 300 to 800 g/m².

10. The molded carpet part according to claim 1, wherein the upper textile material (1) consists of a tufted product.

11. A method for producing a molded carpet part according to claim 1, in which the upper textile material (1) and the multilayer material composite (2-4) are hot embossed with or without the carpet backing (5) in a heated forming device, wherein the upper textile material (1) is moistened before the hot embossing.

12. The method according to claim 11, wherein a forming device comprising heatable forming tools (7, 8) whose temperature can be adjusted independently of one another is used for the hot embossing and that the forming tool facing the upper textile material (1) is operated at a temperature at least 10° C. lower than the forming tool facing the multi-layer material composite (2-4) or the carpet backing (5).

13. The method according to claim 11, wherein the multi-layer material composite (2-4) is needled before the hot embossing with the upper textile material (1)

14. The method according to claim 11, wherein the upper textile material (1) and the multi-layer material composite (2-4) are inserted into the forming device as a loose pile.
